(19) United States
(12) Patent Application Publication
(10) Pub. No.: US 2021/0065488 A1
(43) Pub. Date: Mar. 4, 2021

(54) System and Method for Allowing Access to a Container by Specific Individuals at Specific Times and Locations

(71) Applicant: Mesozoic Technologies LLC, Easton, MD (US)

(72) Inventor: Tien-Seng Chiu, Easton, MD (US)

(73) Assignee: Mesozoic Technologies LLC, Easton, MD (US)

(21) Appl. No.: 16/939,923

(22) Filed: Jul. 27, 2020

Related U.S. Application Data
(60) Provisional application No. 62/893,246, filed on Aug. 29, 2019.

(51) Int. Cl. G07C 9/00

(52) U.S. Cl. CPC G07C 9/00912; G07C 9/00563; G07C 9/00182

(57) ABSTRACT

A system comprising a storage box; an electronic lock; and an electronic control device configured to control the lock. The system further comprises a microprocessor secured to the box and that is configured to receive location, authentication, and current time information to provide an enablement command to the electronic control device to open the electronic lock based on the current time, the location information, and the authentication information, and to provide a disablement command to the electronic control device to prevent opening the electronic lock based on the information received.

### CROSS-REFERENCE

This patent application claims priority to U.S. Provisional Application 62/893,246, filed on Aug. 29, 2019, and incorporated by reference herein in its entirety.

### TECHNOLOGICAL FIELD

The present invention relates generally to a remote authentication system for securing a container.

### BACKGROUND

For businesses, like wineries, that rely on trade shows, farmer's markets, or conduct business at various, busy locations, controlling access to a storage box, such as is used for transporting cash, is a necessity. A simple lock may suffice, however, only the employees working at the event will have access to the key. If the key is lost or illicitly duplicated, the integrity of the box will be compromised. Further, the business owner will not be able to monitor who is accessing the storage box remotely. This may lead to unauthorized and unmonitored opening of the storage box and possible theft of its contents.

Currently, smart lock systems exist to limit access to containers such as cash boxes. However, while these systems may be able to identify unique individuals, they fail to monitor and communicate other facets of secure access such as the location and time of access. Some existing systems also require direct access to the container as well as a unique programming card and are unable to be used or managed remotely. Other existing security systems are not integrated into the container which must be secured and fail to provide an audit trail to track authorized and unauthorized users attempting to access the container, as well as the user's identity, location, and the time of access.

### BRIEF DESCRIPTION OF THE DRAWINGS

FIG. 1 is an overview of the functionality and immediate environment of the storage box according to an embodiment.

FIG. 2 is a detailed flow of commands from the remote smartphone application according to an embodiment.

FIG. 3 is an overview of the functionality of the entire system, including the storage box and the remote smartphone application according to an embodiment.

FIG. 4a is a front view of the storage box when it is closed and locked according to an embodiment.

FIG. 4b is a front view of the storage box when it has been unlocked and opened according to an embodiment.

### DETAILED DESCRIPTION

The present invention will now be described in more detail with reference to the accompanying drawings. The accompanying drawings show both functionality and an exemplary embodiment of the invention. The invention may be embodied in other forms and may have additional functions and should not be construed as a limited to the embodiments or functions set forth herein.

The object of the present invention is to overcome the problems left by the prior art by providing a security system for a storage box that can be controlled remotely to limit access to authorized users at specific locations during a specified time. It is desirable to have a security system for a container which can monitor, authenticate and control an electronic lock integrated into the container using a system to assess a user's request to access the container at a certain location and at a certain time.

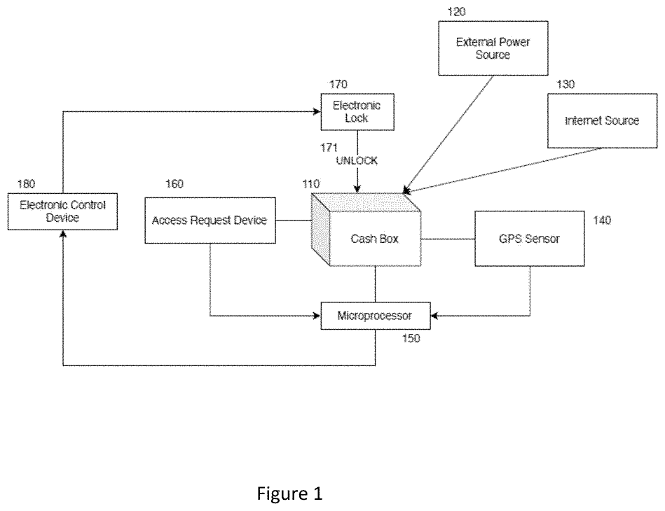

Referring to FIG. 1, a storage box 100, such as a storage box, may comprise a power source 120, an internet source 130, a microprocessor 150, and an electronic control device 180 which controls an electronic lock 170. The power source may comprise a battery or power cord used to provide electric power to the storage box independently. The internet source, such as an ethernet cable or a WiFi connection, may enable the microprocessor to connect with the internet.

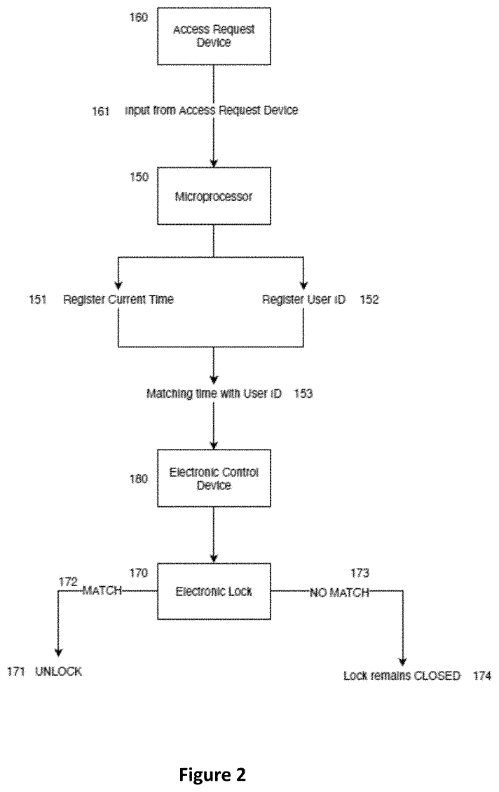

Referring to FIG. 2 a smartphone application 160 may comprise executable code for user authentication 161, a location sensor 162, and a time sensor 163. The user may use the smartphone application to unlock the storage box. The method of user authentication may comprise a fingerprint reader, a passcode, or facial recognition. At the time the user attempts to use the smartphone application, the application may also register the location of the smartphone (assuming that it is local to the storage box) and the time of the attempted access. In an embodiment, the microprocessor 150 may try to match these elements with a database 164 of pre-authorized users, locations, and times. If there is no match 173, no signal will be sent to the microprocessor and the lock will remain closed. If there is a match 172 between all three elements and the pre-authorized database, the microprocessor 150 may send a signal to the electronic control device 180 which unlocks 171 the electronic lock 170. Further, the microprocessor 150 may create an audit trail 165 of both authorized and unauthorized attempts to access the box and may communicate the audit trail with an external database.

In another embodiment, the user and location identification functionalities may be external to the cashbox. The microprocessor 150 may access the external database using either the Internet connection, or smartphone 160 as a relay. The microprocessor may then update the database 164 with then-current authorization parameters provided by the external database. The microprocessor 150 may then match the user and location elements with the database 164 of pre-authorized users, locations, and times. If there is no match 173, no signal will be sent to the microprocessor 150, and the lock will remain closed. If there is a match 172 between all three elements and the pre-authorized database, the application may send a signal to the microprocessor, which may in turn signal the electronic control device 180 and unlock 171 the electronic lock 170. Further, the microprocessor 150 may create an audit trail 165 of both authorized and unauthorized attempts to access the box and may communicate this audit trail with an external database.

In another embodiment the user and location identification functionalities may be incorporated in the smartphone, or may be external to the smartphone in an alternative embodiment. The smartphone 160 may match these elements with the database 164 of pre-authorized of users, locations, and times. If there is no match 173, no signal will be sent to the microprocessor 150, and the lock will remain closed. If there is a match 172 between all three elements and the pre-authorized database, the application may send a signal to the microprocessor, which may in turn signal the electronic control device 180 and unlock 171 the electronic lock 170. Further, the smartphone application 160 may create an audit trail 165 of both authorized and unauthorized attempts to access the box, and may communicate this audit trail with an external database

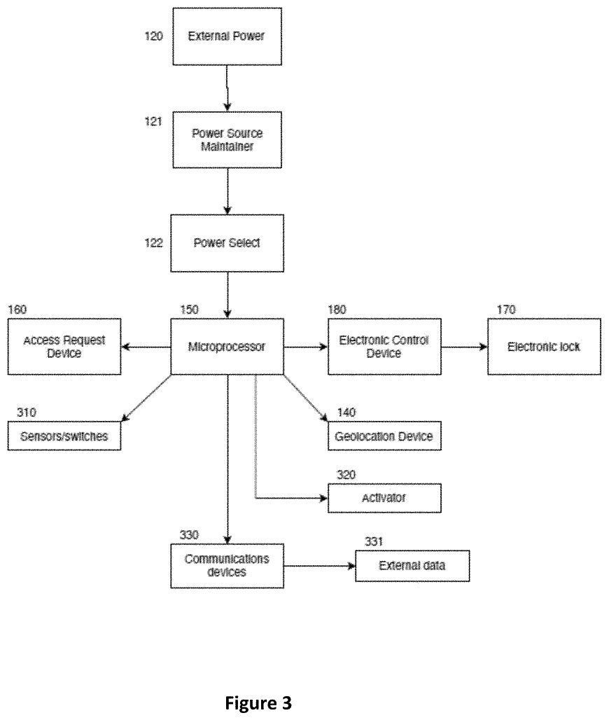

Referring to FIG. 3, the microprocessor may be powered by the external power, which may conduct power through a power source maintainer 121 and may be controlled by a power selector which may place the microprocessor in a lower power mode. The microprocessor may be configured to receive additional signals from a sensor or switch 310 which may detect changes to the storage box. For example, the sensor or switch may detect and attempted opening, send a signal to the activator device 320, which will then signal the microprocessor.

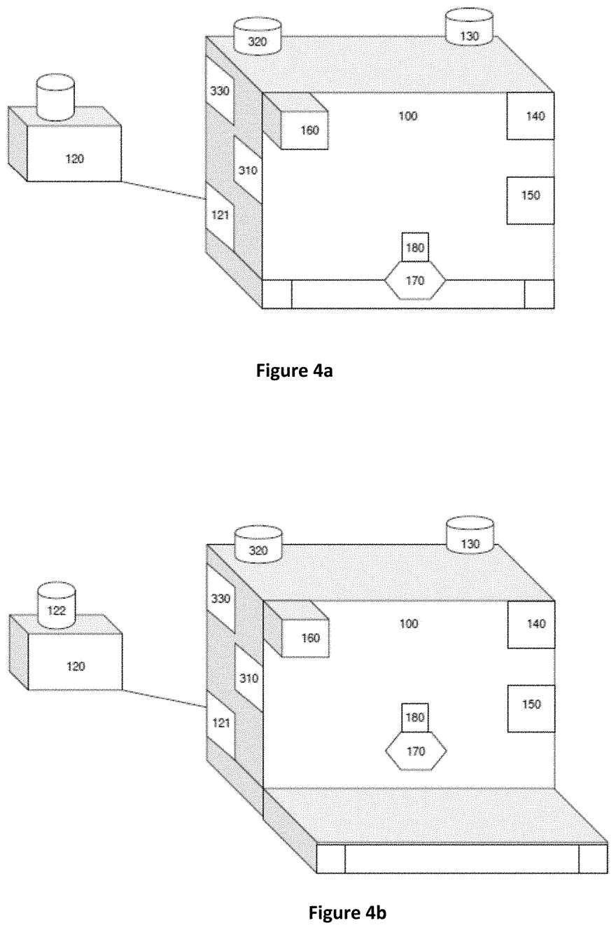

Referring to FIGS. 4a and 4b, the storage box may incorporate some or all of the microprocessor, electronic control device, electronic lock, sensors or switches, activator, internet source, and power source maintainer. The storage box will also be connected to the power source and power selector. Referring to FIG. 4a, the storage box may remain closed until the microprocessor receives a signal from the sensor, switch, or activator (see FIG. 3) and after completion of the processing of FIG. 2. Referring to FIG. 4b, the storage box opens after the required conditions are met.

We claim:

1. A system comprising:
a storage box;
an electronic lock;
an electronic control device configured to control the lock; and
a microprocessor secured to the box and that is configured to receive location, authentication, and current time information to provide an enablement command to the electronic control device to open the electronic lock based on the current time, the location information, and the authentication information, and to provide a disablement command to the electronic control device to prevent opening the electronic lock based on the information received.

2. The system of claim 1,
wherein one or more of the location, authentication, and current time information are received from a smartphone.

3. The system of claim 2,
wherein the smartphone comprises an application enabling communication with the microprocessor via a Bluetooth connection.

4. The system of claim 2,
wherein the smartphone comprises one or more of
a fingerprint reader
a passcode
a facial recognition system
that is configured to recognize the user attempting to access the box.

5. The system of claim 2,
wherein the smartphone comprises a location sensor that is configured to receive and communicate the location information of the smartphone.

6. The system of claim 2,
wherein the smartphone comprises a time sensor that is configured to receive and communicate the exact time at which an authorized or unauthorized user attempts to access the box.

7. The system of claim 1,
wherein the electronic control device is configured to receive the enablement command from the microprocessor and only open the electronic lock the received location, authentication, and current time information match predefined values, and is further configured to keep the electronic lock closed otherwise.

8. The system of claim 1, further comprising a sensor,
wherein the sensor measures indications such as light levels or pressure changes to determine whether the box is open or closed and is configured to send a signal to the microprocessor when the box opens or closes.

9. The system of claim 8,
wherein the microprocessor is configured to receive a signal from the sensor when the box closes and, in turn, send a disablement command to the electronic device.
